(19) United States
(12) Patent Application Publication
(10) Pub. No.: US 2008/0293445 A1
(43) Pub. Date: Nov. 27, 2008

(54) Radio frequency apparatus

(75) Inventors: Antti Piippponen, Tampere (FI); Aarno Parssinen, Espoo (FI); Konsta Sievanen, Jyvaskyla (FI); Tommi Zetterman, Helsinki (FI); Kalle Raiskila, Vantaa (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/892,378

(22) Filed: Aug. 22, 2007

(30) Foreign Application Priority Data
May 22, 2007 (GB) 0709813.0

(51) Int. Cl. H04M 1/00

(52) U.S. Cl. 455/550.1; 455/552.1

(57) ABSTRACT

A radio frequency apparatus comprising an interface configured to receive a command from a radio protocol stack. A command generator configured to generate a plurality of commands from said received command is provided. The apparatus also has configurable hardware, said hardware having a configuration which is controlled in dependence on said generated commands and being arranged to at least one of transmit and receive a radio frequency signal.

### FIELD OF THE INVENTION

The present invention relates to a radio frequency apparatus.

### BACKGROUND

A communication device can be understood as a device provided with appropriate communication and control capabilities for enabling use thereof for communication with other parties. The communication may comprise, for example, communication of voice, electronic mail (email), text messages, data, multimedia and so on. A communication device typically enables a user of the device to receive and transmit communications via a communication system and can thus be used for accessing various applications.

A communication system is a facility which facilitates the communication between two or more entities such as the communication devices, network entities and other nodes. An appropriate access system allows the communication device to access the communication system. An access to the communications system may be provided by means of a fixed line or wireless communication interface, or a combination of these.

Communication systems providing wireless access typically enable at least some mobility for the users thereof. Examples of these include cellular wireless communications systems where the access is provided by means of access entities called cells. Other examples of wireless access technologies include different wireless local area networks (WLANs) and satellite based communication systems.

A typical feature of the modern mobile communication devices is that they are portable, usually small enough to be pocket sized. A modern portable communication device, for example a mobile phone, is already relatively small in size, but the market is demanding ever smaller portable devices.

A wireless communication system typically operates in accordance with a wireless standard and/or with a set of specifications which set out various aspects of the wireless interface. For example, the standard or specification may define if the user, or more precisely user equipment, is provided with a circuit switched bearer or a packet switched bearer, or both. Communication protocols and/or parameters which should be used for the wireless connection are also typically defined. For example, the frequency band or bands to be used for the communications are typically defined.

A portable communication device may be provided with so called multi-radio capabilities. That is, a portable device may be used for communication via a plurality of different wireless interfaces. An example of such device is a multi-mode cellular phone, for example a cellular phone that may communicate in at least two of the GSM (Global System for Mobile) frequency bands 850, 900, 1800 and 1900 MHz or a cellular phone that may communicate based on at least two different standards, say the GSM and a CDMA (Code Division Multiple Access) and/or WCDMA (Wideband CDMA) based systems such as the UMTS (Universal Mobile Telecommunications System). A mobile or portable device may also be configured for communication via at least one cellular system and at least one non-cellular system. Non-limiting examples of the latter include short range radio links such as the Bluetooth™, various wireless local area networks (WLAN), local systems based on the Digital Video Broadcasting via Handheld Terminals (DVB-H) and ultra wide band (UWB) and so on.

In known arrangements the RF signal chain has been controlled by the baseband or the medium access control (MAC), as an integral part of the protocol “stack”. Furthermore, each radio standard has been typically implemented using separate RF transceivers. This has worked well for single-protocol transceivers, such as GSM, because the amount of control has been fairly low, the emphasis being mainly on getting the correct timing behaviour out of the system. However if the number of radio systems incorporated in mobile devices is increased, the RF parts become the size and cost bottleneck in designing cheaper and smaller devices.

It is an aim of one or more embodiments of the invention to address or at least mitigate one or more of the problems.

### SUMMARY OF THE INVENTION

According to a first aspect, there is provided a radio frequency apparatus comprising: an interface configured to receive a command from a radio protocol stack; a command generator configured to generate a plurality of commands from said received command; and configurable hardware, said hardware having a configuration which is controlled in dependence on said generated commands and being arranged to at least one of transmit and receive a radio frequency signal.

According to a second aspect, there is provided a radio frequency apparatus comprising: an interface configured to receive at least one command; and configurable hardware, said hardware being configurable to at least one of transmit and receive signals in accordance with a plurality of different radio protocols, a configuration of said hardware being controlled in dependence on said at least one command such that said configurable hardware is arranged to at least one of transmit and receive a radio frequency signal in accordance with one of said plurality of different radio protocols.

According to a third aspect of the invention, there is provided radio frequency apparatus comprising: an interface configured to receive timing information from a baseband source; timing circuitry configured to provide timing information in dependence on said received timing information; and hardware configured to transmit a radio frequency signal at a time defined by said timing circuitry.

According to a fourth aspect of the invention, there is provided a method comprising: receiving a command from a radio protocol stack; generating a plurality of commands from said received command; configuring hardware, said hardware having a configuration which is controlled in dependence on said generated commands; and at least one of transmitting and receiving a radio frequency signal.

According to a fifth aspect of the invention, there is provided a method comprising: receiving at least one command; configuring hardware, said hardware being configurable to at least one of transmit and receive signals in accordance with a plurality of different radio protocols, a configuration of said hardware being controlled in dependence on said at least one command; and at least one of transmitting and receiving a radio frequency signal in accordance with one of said plurality of different radio protocols.

According to a sixth aspect of the invention, there is provided a method comprising: receiving timing information from a baseband source; providing timing information in dependence on said received timing information; and transmitting a radio frequency signal at a time defined by said provided timing information.

### BRIEF DESCRIPTION OF THE DRAWINGS

For a better understanding of the present invention and as to how the same may be carried into effect, reference will now be made by way of example only to the accompanying figures in which:

FIG. 1 shows schematically a RF (radio frequency) control interface, in an embodiment of the invention;

FIG. 2 shows schematically a single radio device embodying the present invention;

FIG. 3 shows schematically a multiradio device embodying the present invention

FIG. 4 shows schematically a wireless communication device with which embodiments of the present invention can be used.

### DETAILED DESCRIPTION OF THE EMBODIMENTS OF THE INVENTION

Before explaining in detail certain exemplifying embodiments, certain general principles of wireless communication devices are briefly explained with reference to FIG. 4. A portable communication device can be used for accessing various services and/or applications via a wireless or radio interface. A portable wireless device can typically communicate wirelessly via at least one base station or similar wireless transmitter and/or receiver node or directly with another communication device. A portable device may have one or more radio channels open at the same time and may have communication connections with more than one other party. A portable communication device may be provided by any device capable of at least one of sending or receiving radio signals. Non-limiting examples include a mobile station (MS), a portable computer provided with a wireless interface card or other wireless interface facility, personal data assistant (PDA) provided with wireless communication capabilities, or any combinations of these or the like.

FIG. 4 shows a schematic partially sectioned view of a portable electronic device 1 that can be used for communication via at least one wireless interface. The electronic device 1 of FIG. 4 can be used for various tasks such as making and receiving phone calls, for receiving and sending data from and to a data network and for experiencing, for example, multimedia or other content. The device 1 may also communicate over short range radio links such as a Bluetooth™ link. The device 1 may communicate via an appropriate radio interface arrangement of the mobile device.

A portable communication device is typically also provided with at least one data processing entity 3 and at least one memory 4 for use in tasks it is designed to perform. The data processing and storage entities can be provided on an appropriate circuit board and/or in chipsets. This feature is denoted by reference 6. The user may control the operation of the device 1 by means of a suitable user interface such as key pad 2, voice commands, touch sensitive screen or pad, combinations thereof or the like. A display 5, a speaker and a microphone are also typically provided. Furthermore, a wireless portable device may comprise appropriate connectors (either wired or wireless) to other devices and/or for connecting external accessories, for example hands-free equipment, thereto.

The device 1 may also be enabled to communicate on a number of different system and frequency bands. This capability is illustrated in FIG. 4 by the two wireless signals 11 and 21.

Embodiments of the invention relate to software defined radio (SDR), methods in embedded control software and accompanying hardware to control complex radio applications such as a multiradio device in a portable communication device or any other suitable communication device which may or may not be portable. Embodiments of the invention separate the radio frequency (RF) platform in control domain from the baseband and upper protocol layers. The signal path interface can be set at various points, as well as the actual physical control interface, depending on the implementation (e.g. chipset partitioning, implementation technology, etc.). Thus the separation need not be a physical separation although in some embodiments the separation may be a physical separation. Alternatively or additionally, logical or control-domain separation is provided. As long as the logical interface is kept, the implementation on either side of the interface can be changed as it is not visible to the other side.

Embodiments of the invention can be applied to the control of individual radio systems/protocols like GSM (Global system for mobile communications), WCDMA (wideband code division multiple access), WLAN (wireless local area network), BT (Bluetooth), DVB-H (Digital Video Broadcasting-Handheld), WiMax (Worldwide interoperability for microwave access), GPS (global positioning system), Galileo, etc., or any of their extensions like HSDPA (High-Speed Downlink Packet Access), HSUPA (High Speed Uplink Packet Access) and LTE (long term evolution) in the case of 3GPP/UMTS (3^{rd} Generation partnership project/universal mobile telecommunications system). Embodiments of the invention may be used when more than one of the individual radio protocols is operated in a single device i.e. in a multiradio environment.

In some embodiments of the invention a logical separation of the RF platform from the baseband and the rest of the protocol stack are provided. For this, a RF platform embodying the invention may be provided with the following functionality:

Circuitry and/or software to keep the accurate time for each supported radio protocol. This can be achieved using hardware system counters and higher-level software counters, for instance. These elements may reside on the baseband/MAC (medium access control) side. The same information may be duplicated to the RF platform or in the alternative reside only on the RF side. This will depend on the implementation of embodiments of the invention. The accurate time is used to activate and de-activate the radio frequency hardware at a correct time, for example.

With the use of this feature, the RF control interface (towards baseband/MAC) may be changed from hard real-time control to a relaxed mode, where the dynamic operation commands are given some time before the actual activation moment.

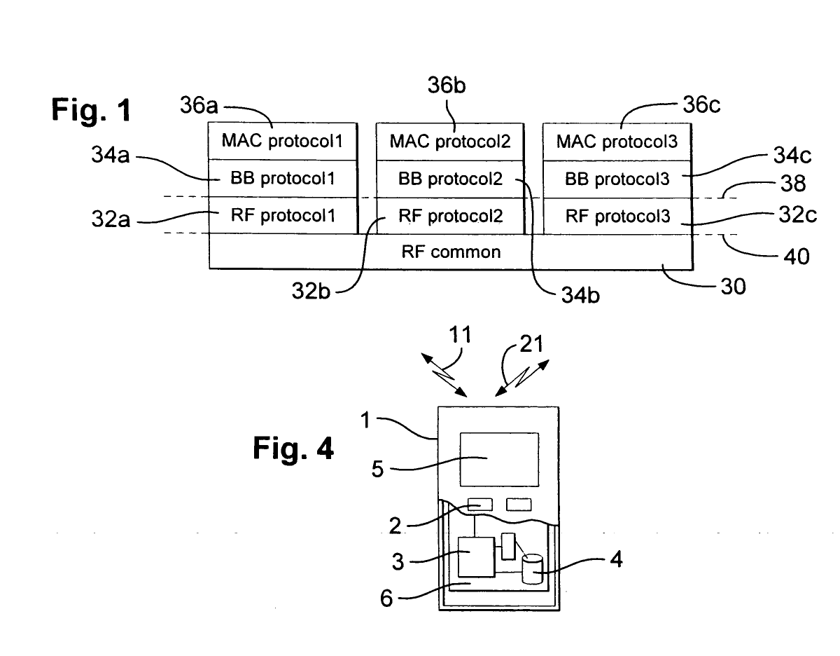

FIG. 1 illustrates an interface implementation according to one embodiment of the invention. A first common RF layer 30 is a generic interface layer. On that generic interface layer 30 sits one or more a RF control interface 32 which is parameterized for each radio protocol. In the example shown in FIG. 1 there are three different radio protocols which can be any one or more of the various protocols discussed above or any other radio protocol. The respective different specific radio protocol layers are referenced 32a-c respectively.

The RF protocol blocks or layers 32 function as a translation layer, translating from the protocol specific parameters to generic ones. Below are some examples of protocol specific parameters and the corresponding generic parameters.

| Specific parameter | Generic parameter |
|---|---|
| Channel number | Carrier frequency (in Hz, for instance) |
| (e.g. GSM: ARFCN) | |
| Transmit power class | Transmit power level (in dBm, for |
| (e.g. 3gpp: TPC_cmd) | instance) |
| Time (e.g. GSM: quarter | RF platform hardware clock reference |
| symbol #, frame #) | time (for instance) |

The control interface can be set at the true generic level (e.g. layer 30), or protocol specific parameterized generic level (e.g. layer 32), or at any level in between. The protocol specific level can be extended upwards; for example in GSM it could be beneficial to issue dynamic operation control commands for entire slots (as opposed to issuing separate start and stop commands), or frames (example frame [RX 0 0 TX 0 MON MON 0]) and patterns (e.g. use this frame pattern until otherwise commanded). The extension commands would be then parsed to single dynamic control commands on the RF platform.

On each of the radio frequency protocol layers 32a-c is a respective baseband protocol layer 34a-c. On each of the baseband protocol layers 34a-c is a respective MAC protocol layer 36a-c.

One possible logical border between RF and baseband (that is between layers 32 and 34) is defined as follows: baseband processes data symbols at symbol rate, and RF processes time-domain waveforms. This would be the border between the RF layers 32 and the baseband layers 34. This enables the RF to correct its deviations from an ideal.

In an alternative embodiment of the invention, the RF layers take care of “real-time processing” and the baseband and/or MAC layers operate on data buffers (in this embodiment parts of the baseband are considered to reside on the RF platform).

Whatever the signal path interface is, the RF is responsible for transmitting the time-domain signal at the correct time. If the baseband can buffer transmit data, its timing constraints are relaxed. If short buffers are used, also the baseband must operate on the correct time and more timing synchronization is needed (e.g. delay matching on the signal chain). On the receiver side, the RF platform typically does not demodulate the data, and thus does not synchronize to the incoming signal.

The division between RF platform and baseband from signal path point of view is a result of the logical architecture. In preferred embodiments of the invention, the logical division between the RF platform or layer and the baseband have only a small number of control dependencies. This means that changes to either the RF platform or the baseband layer can be easily made.

The control information that is passed through the RF-baseband interface is listed below. The list is by way of example; new radio standards may bring in other controls, which can be added later on. Some protocols may not use all of the types of control information listed below.
Synchronization and adjustment of system counters between RF and baseband/MAC. This is present for all supported radio protocols in preferred embodiments of the invention.
Radio protocol configuration information to determine a suitable signal path for radio frequency and associated digital hardware. This information comes from higher protocol stacks of a specific radio system or from some other relevant source This information may comprise protocol variant used (802.11a/b/g, for instance), diversity, the used RF band, and packet type (including channel bandwidth, modulation, and data rate, which can change from packet to packet). Some of these issues may be also embedded to standard protocol commands and decoded at RF controlling software. One example is GSM channel number that may exclusively indicates the used RF band of the system. In these cases control interface supports both variants and has internal mechanisms in RF controlling software to make the final decision in each case.
Dynamic performance control information. This may include for instance the used channel number and transmitter output power.
Dynamic operation control information, including activation and de-activation times of radio transceiver. This may include sequential or ad hoc based information from the protocol. HARQ (hybrid automatic repeat request) is one example of the latter one.
Control loop feedback. Using some embodiments of the invention, the RF platform can do independently any operations not requiring data de-modulation or synchronization. This may include receiver AGC (automatic gain control) and transmitter output power calibration, but not for example AFC (automatic frequency correction (which requires measuring the frequency error at the receiver).
Information parameters, such as RSS (received signal strength) measurement report from radio frequency to baseband. The baseband can deliver link performance parameters like SNR (signal-to-noise ratio), SIR (signal-to-interference ratio), BER (Bit error rate), etc. for the radio frequency part to optimize its power consumption in good link conditions.
Mechanism to synchronize samples in the signal path between radio frequency and baseband. This can be made any suitable manner and may depend on the method of implementing the physical interface.

In some embodiments of the invention, it is considered that at a certain abstraction level, all radio protocols share the same functionality when considering the radio frequency control. This allows a generic but parameterized control interface implementation, in some embodiments of the invention. For instance, turning the transmitter on is a generic command, with the exact representation of the time being a protocol specific parameter.

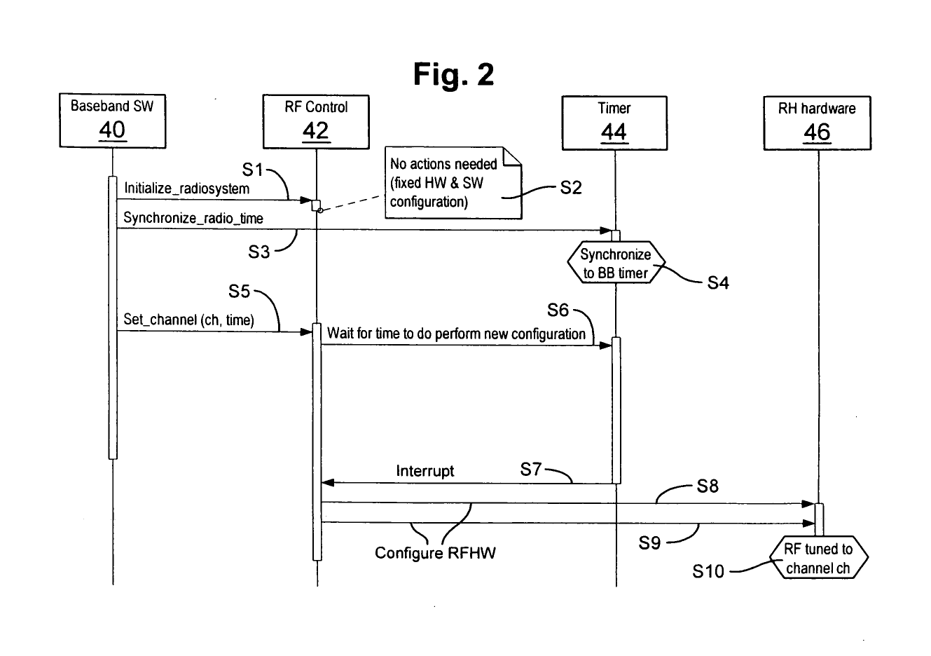

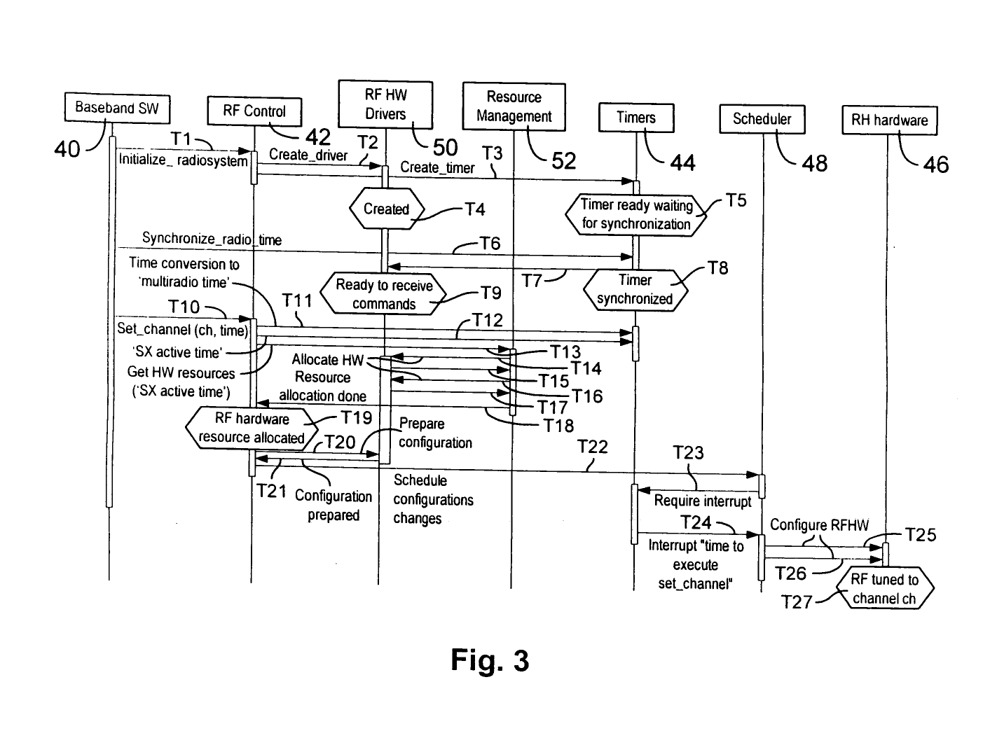

Two embodiments of the invention will now be described with reference to FIGS. 2 and 3. One or more of the above described pieces of control information may be passed through the interface. As will be explained in more detail later, the interface is defined between the baseband software and the RF controller.

A first embodiment of the invention is illustrated in FIG. 2. In the embodiment shown in FIG. 2, the baseband is connected to simple single-radio radio frequency hardware. The device of FIG. 2 comprises baseband software 40, a radio frequency controller 42, a timer 44 and radio frequency hardware 46. There is a specified interface between baseband software 40 and the radio frequency control entity, which abstracts radio frequency related implementation issues and provides consistent control view of different kinds of radio frequency hardware 46. The baseband software connects via the interface to the RF controller 42 and the timer 44. The RF controller is connected to the timer and the RF hardware 46, additionally.

The functionality of the components of the device will now described by way of a signal flow between the components, illustrated in FIG. 2.

The baseband software 40 is arranged in step S1 to send a initialise radio system command to the radio frequency controller 42.

In step S2, no actions are required by the RF controller as this has a fixed hardware and software configuration. However, this command does notify the control that the radio controller that the radio system is being initialised. In this embodiment, the driver can be statically allocated and does not need to be dynamically loaded/created when radio connection is initialized.

In step S3, the baseband software is arranged to send a command to the timer 44 to synchronise the radio time. In this embodiment, the timer is in the RF domain.

In state S4, the timer 44 is synchronized to baseband timer, providing RF control a timing reference consistent with baseband time. This is a prerequisite for RF control to be able to execute dynamic configuration commands. The baseband timer may be part of the baseband software or may be a separate component which is connected via the interface to the RF timer 44.

In step S5, the baseband software 40 is arranged to send a command to set a channel, including for example the channel and time information. This command is sent to the RF controller 44. The time information indicates when the RF components are to be tuned to the specified channel.

In step SS6, the RF controller requests timing information from the timer 44. In particular the RF controller passes the time received in the command to the timer 44.

The timer 44 in step S7, sends an interrupt at the time set by the baseband software 40 to the RF controller. In the alternative, the interrupt may be sent a predetermined time before or after the specified time.

In steps S8 and S9, the RF controller responds to the received interrupt to send a command to the radio frequency hardware 46 to cause that hardware to be configured. For illustrational purposes writing a configuration would typically require write operations on multiple control registers and for this reason this is represented diagrammatically by two steps. In practice there may be more or less steps.

In state S10, the RF hardware is tuned to the defined channel.

In some embodiments of the invention, the baseband software may be regarded as being a baseband controller.

FIG. 3 illustrates an embodiment of the invention where the underlying RF hardware is advanced multiradio. The multiradio in this embodiment of the invention is capable of dynamically share resources with different simultaneously active radios.

Those elements which correspond to those shown in FIG. 2 are referenced by the same numerals. It should be appreciated that in the embodiment shown in FIG. 3, there are a plurality of timers, depending on the number of radio protocols which are supported and/or the number of channels which are simultaneously supported. The RF hardware 46 will be capable of supporting a number of different radio channels at the same time. The supported channels may be in accordance with the same or different protocols or standards.

Also provided are RF hardware drivers 50, a resource manager 52 and a scheduler. The baseband software 40 is connected to the RF controller 42 and the timers 44. The RF controller 42 is connected to the RF hardware drivers 50, the timers 44, and scheduler 48. The RF hardware drivers 50 are arranged to connect to the timers 44 and the resource manager 52. The timers 44 are connected to the scheduler 48. The scheduler 48 is connected to the radio frequency hardware 46.

In step T1, the baseband software 40 is arranged to send an initialise radio system command to the RF controller 42. This will specify a given radio protocol or standard.

In step T2, the RF controller is arranged to send a create driver command to the RF hardware driver. This is a command to create a driver for a given protocol or standard.

In step T3, the RF controller 42 sends a create timer command to the timer 44.

In state T4, the hardware driver for the specified protocol is created but does not have common time concept with baseband. Before the hardware driver can execute dynamic configuration commands, it has to synchronize its time with baseband.

In state T5, the timer is arranged to set up the timer for the specified protocol. The set up timer is ready and waiting for synchronisation.

In step T6, the baseband software 40 sends a synchronise radio command to the timer 44.

In step T7, a message is sent by the timer to the hardware drivers indicating the timer are being synchronised.

In state T8, the timer is synchronised to the baseband timer.

In state T9, the RF hardware driver is in a state to receive commands.

In step T10, the baseband software sends a set channel and time command to the RF controller as described in relation to FIG. 2.

In step T11, the RF controller sends the time to the timer. This time is converted to multiradio time. In a multiradio device, to be able to operate with control issues dealing with multiple radios (e.g. resource sharing, interoperability etc.) there may be a common time concept with different radios. One scenario is that each radio protocol time reference in control commands coming from different radio protocol stacks is converted into the internal time presentation, called “multiradio time”. In step T12, the RF controller sends a SX active time command to the timers 44. This command is used to get the actual synthesizer activation time (which takes into account synthesizer settling time). In this embodiment all time calculations are performed by Timers—object (which knows the relations between different radio protocol times and multiradio time)]

In step T13, the RF controller 42 sends a command to the resource manager 52 instruction for hardware resources at the active time.

In step T14, the resource manager sends a message to the RF hardware drivers and receives in step T15 a response there from. This message exchange will result in the allocation of hardware resources. In some embodiments of the invention, the allocation of hardware resources will requires the exchange of several messages. In the embodiment of FIG. 3, there is a further message sent by the resource manager 52 to the RF hardware drivers and a response received there from as indicated by steps T16 and T17. However in some embodiments these steps are optional.

In step T18, a message is sent from the resource manager to the RF hardware drivers indicating that the resource management has been carried out.

In state T19, the RF controller notes the RF hardware resources allocated and sends a command to the RF hardware drivers instructing the drives to prepare configuration in step T20. The configuration is a bit mask written to the control registers, and it is calculated beforehand to by prepare the configuration.

In step T21, the RF hardware drivers send a message indicating that the drivers are configured.

In step T22, the RF controller sends a message to the scheduler 48 for the scheduling of configuration changes.

In step T23, the scheduler 48 sends a message to the timer requiring an interrupt. In step T24, the timer provides the requested interrupt based on the time information included in the message sent from the baseband software to the RF controller.

In step T25, the scheduler sends a message to the RF hardware in response to the interrupt. This causes the RF hardware to be tuned to the channel sent by the baseband software to the RF controller in step T27. As illustrated in FIG. 3 by the presence of step T26, the schedule may send a plurality of messages or commands to the RF hardware so that it can configure at least part of itself to be tuned to the required channel. The actual register writes using the pre-calculated bit masks.

In both embodiments shown in FIGS. 2 and 3, the same set of interface commands (initialize_radiosystem, synchronize_radiotime, set_channel) is used to control the radio frequency hardware, and internal control mechanism for timing, resource management and configuration is hidden behind the interface. The interface is between the baseband software and the RF controller.

Either one of the embodiments described may be arranged to provide a negative acknowledge response to the baseband software if the RF part is not able to react to a command provided by the baseband software to the RF controller. That response may be generated and sent by the RF controller to the baseband software.

It should be appreciated that either one of the embodiments may be arranged to provide an acknowledgement of a command received from the baseband software.

The commands which are provided by the baseband software may be dynamic operation commands or for the reservation of dynamic operation. The commands can result in the dynamic reconfiguration of the RF hardware. As can be seen from the embodiments shown in FIGS. 2 and 3, one command issued by the baseband software can cause a number of additional commands to be generated in the RF part. In this way the number of commands that need to pass through the interface can be minimised. The additional commands which are generated are able to take into account the command received from the baseband software, the internal state of one or more of the RF components and confirmed reservations for dynamic operation. The configuring of hardware components will take into account the additional commands, the commands received from the baseband software and reservations for dynamic operation.

The commands may reserve hardware for the use on one specific radio protocol.

The RF hardware in either of the embodiments shown in FIG. 2 and 3 may comprise signal waveform processing apparatus. The signal waveform processing apparatus may comprise a control unit and signal waveform processing unit, comprising one or more radio frequency signal paths. There may be signal processing on the baseband side of the interface arranged to provide one or more digital baseband signal paths. In one embodiment of the invention there is a plurality of parallel signal paths on the baseband and RF side of the interface each of which is in compliance with the same interface.

The command may be supplied asynchronously ahead of the activation or deactivation channel. In some embodiments of the invention the interface can be regarded as receiving signals from the baseband part via an asynchronous channel. This means that the timing control is loose or relatively non accurate compared to the time control in the RF domain.

In some embodiments of the invention, the interface is generic for all radio protocols and therefore may give flexibility in multiradio solutions to use generic RF and protocol specific baseband, protocol specific RF and generic baseband, or generic RF and generic baseband.

The baseband software may include a data buffering capability. In the alternative, a separate data buffer can be provided.

It should be appreciated that the baseband software can be implemented as a computer program run on a suitable processor. In alternative embodiments of the invention, a circuitry may be provided to implement the process instead of using software.

Likewise one or more of the RF controller, the RF drivers, the resource managers, the timers, and the scheduler may be implemented in software at least partially and/or at least partially by circuitry.

It should be appreciated that whilst embodiments of the invention have been described in relation to devices such as mobile terminals, embodiments of the invention are applicable to any other suitable type of devices suitable for communication via a communications network.

In alternative embodiments of the invention, the invention may be applied to a base station or the like.

It will be understood that embodiments of the present invention can be implemented by a computer program. The computer program may be provided with one or more computer executable components for carrying out one or more steps. The computer program may be provided by a computer carrying media.

Embodiments of the invention may have one or more of the following advantages:

The RF platform can be developed independently of baseband (PHY-physical layer) and MAC, and vice versa, as long as the interface specification is adhered to, i.e. the system partitioning (architecture) is not changed. Thus almost complete freedom of independent development may be achieved. The physical interface can be realized at device integration, in some embodiments of the invention.

The RF platform may support multiradio control and may manage the hardware resources much more efficiently.

The RF platform may incorporate independent calibration management and support active mode calibrations.

In some embodiments of the invention, most of the RF control loops such as receiver automatic gain control and transmitter power control can be RF internal, which reduces dependencies to baseband, as well as baseband control load.

Although the present invention has been described with reference to examples and the accompanying drawings, it is clear the invention should not be regarded as being restricted thereto but can be modified in several ways within the scope of the claims.

1. A radio frequency apparatus, comprising:
an interface configured to receive a command from a radio protocol stack;
a command generator configured to generate a plurality of commands from said received command; and
configurable hardware, said configurable hardware comprising a configuration which is controlled in dependence on said generated commands and configured to at least one of transmit and receive a radio frequency signal.

2. The radio frequency apparatus as claimed in claim 1, wherein said radio protocol stack comprises a baseband source.

3. The radio frequency apparatus as claimed in claim 1, wherein said command generator comprises a processor.

4. A radio frequency apparatus, comprising:
an interface configured to receive at least one command; and
configurable hardware, said configurable hardware being configured to:
at least one of transmit and receive signals in accordance with a plurality of different radio protocols,
wherein a configuration of said configurable hardware being controlled in dependence on said at least one command such that said configurable hardware is further configured to:
at least one of transmit and receive a radio frequency signal in accordance with one of said plurality of different radio protocols.

5. A radio frequency apparatus, comprising:
an interface configured to receive timing information from a baseband source;
a timing circuitry configured to provide timing information in dependence on said received timing information; and
hardware configured to transmit a radio frequency signal at a time defined by said timing circuitry.

6. The apparatus as claimed in claim 5, wherein said timing information provided by said timing circuitry comprises accurate timing information.

7. The apparatus as claimed in claim 5,.wherein said hardware comprises at least one component which is configured to be at least one of activated and deactivated in dependence on said timing circuitry timing information.

8. The apparatus as claimed in claim 5, wherein said interface is further configured to receive said timing information via an asynchronous channel.

9. The apparatus as claimed in claim 5, wherein said interface is further configured to receive at least one command for controlling said radio frequency apparatus.

10. The apparatus as claimed in claim 9, wherein said timing information from said baseband source is part of at least one command.

11. The apparatus as claimed in claim 9, wherein said hardware is configurable and is configured in response to at least one command.

12. The apparatus as claimed in claim 11, wherein said configurable hardware is reserved in response to said at least one command.

13. The apparatus as claimed in claim 3, wherein said radio frequency apparatus is configured to generate at least one additional command in dependence on a command received by said interface.

14. The apparatus as claimed in claim 1, wherein said radio frequency apparatus is configured to generate at least one additional command in dependence on at least one of a status of said configurable hardware and reservations of said configurable hardware.

15. The apparatus as claimed in claim 1, wherein said interface is further configured to receive control information.

16. The apparatus as claimed in claim 15, wherein said control information comprises at least one of dynamic performance control information, dynamic operation control information, control loop feed back information, link performance parameters, and radio protocol configuration information.

17. The apparatus as claimed in claim 1, wherein said interface is further configured to receive at least one generic parameter independent of a radio protocol.

18. The apparatus as claimed in claim 1, wherein said interface is further configured to receive at least one radio protocol specific parameter.

19. The apparatus as claimed in claim 1, wherein said configurable hardware is configured to provide a plurality of signal paths at the same time.

20. The apparatus as claimed in claim 1, wherein said configurable hardware is configured to provide a signal path for a plurality of different radio protocol signals.

21. The apparatus as claimed in claim 1, wherein said interface is further configured to be utilized by a plurality of different radio protocols at the same time.

22. A communications apparatus, comprising:
a radio frequency apparatus, said radio frequency apparatus, comprising an interface configured to receive a command from a radio protocol stack;
a command generator configured to generate a plurality of commands from said received command;
configurable hardware, said configurable hardware comprising a configuration which is controlled in dependence on said generated commands and configured to at least one of transmit and receive a radio frequency signal; and
a baseband source.

23. The communications apparatus as claimed in claim 22, wherein said baseband source comprises a baseband protocol layer.

24. The communications apparatus as claimed in claim 22, wherein said baseband source comprises at least one data buffer for buffering data.

25. The communications apparatus as claimed in claim 22, wherein said radio frequency apparatus is configured to carry out real time processing.

26. The communications apparatus as claimed in claim 22, wherein said baseband source is configured to process data symbols at a symbol rate, and said radio frequency apparatus is configured to process time domain waveforms.

27. A method, comprising:
receiving a command from a radio protocol stack;
generating a plurality of commands from said received command;
configuring hardware, said hardware comprising a configuration which is controlled in dependence on said generated commands; and
at least one of transmitting and receiving a radio frequency signal.

28. A method, comprising:
receiving at least one command;
configuring hardware, said hardware being configurable to at least one of transmit and receive signals in accordance with a plurality of different radio protocols, a configuration of said hardware being controlled in dependence on said at least one command; and
at least one of transmitting and receiving a radio frequency signal in accordance with one of said plurality of different radio protocols.

29. A method, comprising:
receiving timing information from a baseband source;
providing timing information in dependence on said received timing information; and
transmitting a radio frequency signal at a time defined by said provided timing information.

30. A computer program embodied on a computer readable medium, the computer program comprising program code to perform:
receiving a command from a radio protocol stack;
generating a plurality of commands from said received command;
configuring hardware, said hardware comprising a configuration which is controlled in dependence on said generated commands; and
at least one of transmitting and receiving a radio frequency signal.

31. A radio frequency apparatus, comprising:
interface means for receiving a command from a radio control protocol stack;
generator means for generating a plurality of commands from said received command; and
communication means for at least one of transmitting and receiving a radio frequency signal.

32. A radio frequency apparatus, comprising:
interface means for receiving at least one command; and
communication means for at least one of transmitting and receiving signals in accordance with a plurality of different radio protocols,
wherein a configuration of said communication means is controlled in dependence on said at least one command such that said communication means further for at least one of transmitting and receiving a radio frequency signal in accordance with one of said plurality of different radio protocols.

33. A radio frequency apparatus, comprising:
interface means for receiving timing information from a baseband source;
timer means for providing timing information in dependence on said received timing information; and
communication means for transmitting a radio frequency signal at a time defined by said timer means.
